(19) United States
(12) Patent Application Publication
(10) Pub. No.: US 2026/0045993 A1
(43) Pub. Date: Feb. 12, 2026

(54) METHODS AND APPARATUS IN WIRELESS COMMUNICATION SYSTEM

(71) Applicant: Samsung Electronics Co., Ltd., Suwon-si, Gyeonggi-do (KR)

(72) Inventors: Santanu MONDAL, Bangalore (IN); Diwakar SHARMA, Bangalore (IN); Dattaraj Dileep Raut MULGAONKAR, Bangalore (IN); Karthik MURALIDHAR, Bangalore (IN); Youngbum KIM, Suwon-si (KR); Junyung YI, Suwon-si (KR)

(21) Appl. No.: 19/101,129

(22) PCT Filed: Aug. 10, 2023
(86) PCT No.: PCT/KR2023/011818

§ 371 Date: Feb. 4, 2025

(30) Foreign Application Priority Data
Aug. 12, 2022 (IN) 202241046218
Jul. 13, 2023 (IN) 2022 41046218

(51) Int. Cl. H04B 7/06; H04W 72/232

(52) U.S. Cl. CPC H04B 7/0626; H04W 72/232

(57) ABSTRACT

The disclosure relates to a 5G or 6G communication system for supporting a higher data transmission rate. Embodiments herein disclose methods for managing energy usage in a wireless network (1000) by a network apparatus (200). The method includes sending a configuration message including at least one CSI-RS port muting information to a UE (100) in a wireless network (1000) for indicating to the UE (100) about a muted CSI-RS port to control a UE measurement of CSI using a CSI-RS signal. Further, the method includes controlling the energy usage in the wireless network (1000) based on the configuration message comprising the CSI-RS port muting information and a subsequent UE measurement report.

### TECHNICAL FIELD

Embodiments disclosed herein relate to wireless communication networks, and more particularly related to methods and a network apparatus to saving energy in the wireless communication networks using port muting information (e.g., Channel State Information Reference Signal (CSI-RS) port muting information).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHZ” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

As per study item (SI) objectives for network-energy savings (NES), the following gaps have been identified:

Definition of a base station energy consumption model [RAN1]: The base station energy consumption model adapts a framework of the power consumption modelling and an evaluation methodology of TR38.840 to a base station side, which includes relative energy consumption for downlink (DL) and uplink (UL) (considering factors like power amplifier (PA) efficiency, a number of transmission radio unit (TxRU), base station load, etc.), sleep states and the associated transition times, and one or more reference parameters/configurations.

Definition of an evaluation methodology and KPIs [RAN1]: The evaluation methodology should target for evaluating a system-level network energy consumption and energy savings gains, as well as assessing/balancing impact to network and user performance ((e.g., spectral efficiency, capacity, UE packet throughputs (UPT), latency, handover performance, call drop rate, initial access performance, service level agreement (SLA) assurance related Key Performance Indicators (KPIs), energy efficiency, and UE power consumption, complexity). The evaluation methodology should not focus on a single KPI, and should reuse existing KPIs whenever applicable, where the existing KPIs are found to be insufficient new KPIs may be developed as needed. Work groups (WGs) will decide KPIs to evaluate and how.

Study and identify techniques on the gNB and UE side to improve network energy savings in terms of both BS transmission and reception, which may include:
a) How to achieve more efficient operation dynamically and/or semi-statically and finer granularity adaptation of transmissions and/or receptions in one or more of network energy saving techniques in time, frequency, spatial, and power domains, with potential support/feedback from UE, and potential UE assistance information [RAN1, RAN2],
b) Information exchange/coordination over network interfaces [RAN3], and
c) Other techniques are not precluded.

There is a need to prioritize idle/empty and low/medium load scenarios (the exact definition of such loads is left to the study), and different loads among carriers and neighbor cells are allowed.
the following gaps were identified in spatial-domain NES techniques. There is a need for techniques and enhancements for the adaptation of number of spatial elements of the gNB, including (but not limited to) the following aspects:
a) Spatial elements may include antenna element(s), TxRU(s) (with subarray/full-connection), antenna panel(s), Transmission-reception point(s) (TRxP(s)) (co-located or geographically separated from each other), logical antenna port(s) (corresponding to specific signals and channels),
b) Impact to UE operations from dynamic adaptation of spatial elements, e.g. measurements, CSI feedback, power control, PUSCH/PDSCH repetition, SRS transmission, TCI configuration, beam management, beam failure recovery, radio link monitoring, cell (re) selection, handover, initial access, etc.,
c) Feedback/assistance information from the UE required for support dynamic spatial element adaptation; for example, CSI measurement and reports, SR, etc,
d) Signaling methods, including reduced signaling, for enabling dynamic spatial element adaptation; for example, group-common L1 signaling, broadcast signaling, MAC CE, etc,
c) Dynamic TRxP adaptation,
f) Study of triggering on/off conditions for TRxP(s),
g) This may not have specification impact and could potentially be up to network implementation,
h) Study of SSB, PL-RS, TRS, and CSI-RS re-configuration and its impact to initial access procedure, synchronization and measurements performed by the idle/inactive/connected UE,
i) Dynamic logical port adaptation and efficient port reconfigurations
j) Study details of signaling the port (e.g., NZP CSI-RS ports) (if required to be known by the UE),
k) Study dynamic adaptation (including activation/deactivation) of CSI measurement or report configuration for port adaptation,
l) Joint adaptation of spatial-domain, frequency-domain and/or power-domain configurations to avoid coverage loss, and
m) Grouping of Ues to reduce transmission and reception footprint at the gNB; including but not limited to grouping of users in spatial domain.

It is desired to address the above mentioned disadvantages or other short comings or at least provide a useful alternative.

The principal object of the embodiments herein is to disclose methods and systems for saving energy in wireless networks (in a spatial-domain) using port muting information (e.g., CSI-RS port muting information).

Another object of the embodiments herein is to send a configuration message including the CSI-RS port muting information to a UE in the wireless network for indicating to the UE about a muted CSI-RS port to control a UE measurement of CSI using a CSI-RS signal.

Another object of the embodiments herein is to control the energy usage in the wireless network based on the configuration message comprising the CSI-RS port muting information and a subsequent UE measurement report.

### DISCLOSURE OF INVENTION

### Solution to Problem

Accordingly, the embodiments herein provide methods for managing energy usage in a wireless network. The method includes sending, by a network apparatus, a configuration message including at least one CSI-RS port muting information to at least one UE in the wireless network for indicating to the at least one UE about at least one muted CSI-RS port to control a UE measurement of CSI using a CSI-RS signal. Further, the method includes controlling, by the network apparatus, the energy usage in the wireless network based on the configuration message comprising the at least one CSI-RS port muting information and a subsequent UE measurement report.

In an embodiment, sending, by the network apparatus, the configuration message including the at least one CSI-RS port muting information to the at least one UE includes indicating, by the network apparatus, one of: at least one CSI-RS port, a single group of CSI-RS ports, a multiple groups of CSI-RS ports for port muting to the at least one UE, receiving, by the network apparatus, a measurement report from the at least one UE based on the indication, and sending, by the network apparatus, the configuration message comprising the at least one port muting information to the at least one UE in the wireless network based on the measurement report received by the network apparatus. The measurement report includes a preference and measurement information about the port muting for one of: the at least one CSI-RS port, the single group of CSI-RS ports, and the multiple groups of CSI-RS ports

In an embodiment, the method includes receiving, by the network apparatus, at least one measurement report for a set of Synchronization Signal Block (SSB) beams by the at least one UE conducting at least one measurement on the set of SSB beams. The UE does not find a CSI-RS beam associated with an optimal SSB beam from the set of SSB beams. Further, the method includes selecting and activating, by the network apparatus, the set of CSI-RS beam from the set of SSB beams based on the at least one measurement report.

In an embodiment, receiving, by the network apparatus, the at least one measurement report for the set of SSB beams includes performing, by the network apparatus, at least one of: enabling all CSI-RS ports and beams associated with the set of SSB beams, transmitting a CSI-RS beams or a discovery RS beams to identify which CSI-RS beams to be activated per bandwidth part (BWP) and per CC basis, and sending a Physical Downlink Control Channel (PDCCH) to trigger the UE to send a positioning information.

In an embodiment, the positioning information is determined using at least one of: a signal that is introduced in a downlink control information (DCI) to trigger positioning information feedback from the at least one UE and mapping of location with the CSIRS measurements.

In an embodiment, the at least one measurement report includes at least one of: a Reference Signal Received Power (RSRP) measurement report, a Signal to Interference Noise Ratio (SINR) measurement report, a Reference Signal Received Quality (RSRQ) measurement report, a CSI-RS Resource Indicator (CRI), a Ranking Indicator (RI), a Layer Indicator (LI), a Pre-coding Matrix Indicator (PMI), and a Channel Quality Indicator (CQI).

In an embodiment, the at least one CSI-RS port muting information involves one of: enabling the at least one antenna element and the at least one antenna sub-array associated to a logical antenna port and disabling the at least one antenna element and the at least one antenna sub-array associated to the logical antenna port.

In an embodiment, the at least one CSI-RS port muting information is associated with at least one of: at least one CSI-RS port, at least one single group of CSI-RS ports, and at least one multiple groups of CSI-RS ports.

Accordingly, the embodiments herein provide a network apparatus including a CSIRS port muting configuration controller coupled with a processor and a memory. The CSI-RS port muting configuration controller is configured to send a configuration message comprising at least one CSI-RS port muting information to at least one UE in the wireless network for indicating to the at least one UE about at least one muted CSIRS port to control a UE measurement of CSI using a CSI-RS signal. Further, the CSIRS port muting configuration controller is configured to control the energy usage in the wireless network based on the configuration message comprising the at least one CSI-RS port muting information and a subsequent UE measurement report.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 depicts example beams used in a wireless network, according to embodiments as disclosed herein;

FIG. 2 shows various hardware components of a network apparatus, according to the embodiments as disclosed herein; and

FIG. 3 is a flow chart illustrating a method for managing energy usage in the wireless network, according to embodiments as disclosed herein.

FIG. 4 illustrates a structure of a base station according to an embodiment of the disclosure.

FIG. 5 illustrates a structure of a UE according to an embodiment of the disclosure.

### BEST MODE FOR CARRYING OUT THE INVENTION

Before undertaking the description below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5^{th} generation (5G) systems or new radio (NR) systems, etc. In addition, the technical schemes of the embodiments of the application can be applied to future-oriented communication technologies. In addition, the technical schemes of the embodiments of the application can be applied to future-oriented communication technologies.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods for managing energy usage in a wireless network. The method includes sending, by a network apparatus, a configuration message including at least one CSI-RS port muting information to at least one UE in the wireless network for indicating to the at least one UE about at least one muted CSIRS port to control a UE measurement of CSI using a CSI-RS signal. Further, the method includes controlling, by the network apparatus, the energy usage in the wireless network based on the configuration message comprising the at least one CSIRS port muting information and a subsequent UE measurement report.

In an embodiment, all CSI-RS resource(s) (which can be one or more) in the CSI-RS resource set for channel measurement are associated with each sub-configuration provided in a CSI report configuration. Each CSI-RS resource is associated with all the sub-configurations. Resources in the resource set for channel measurement have the same number of antenna ports.

Given that the antenna elements, sub-arrays and panels consume the greatest amount of power in a base-station, muting of these spatial elements can provide significant energy savings for the wireless network. The methods mentioned here can be used for saving energy in the wireless networks (in the spatial-domain) by applying port muting techniques.

Referring now to the drawings, and more particularly to FIG. 1 through 3, where similar reference characters denote corresponding features consistently throughout the figures, there are shown at least one embodiment.

FIG. 1 depicts example beams used in a wireless network (1000), according to embodiments as disclosed herein. The wireless network (1000) can be, for example, but not limited to a fourth generation (4G) network, a fifth generation (5G) network, a sixth generation (6G) network, an Open Radio Access Network (ORAN) or the like. In an embodiment, the wireless network (1000) includes a UE (100) and a network apparatus (200). The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network apparatus (200) can be, for example, but not limited to a gNB, a eNB, a new radio (NR) trans-receiver or the like.

Consider that the CSI-RS port is to be muted. The UE feedback information can be used to identify which CSI-RS ports can be muted. In an example, consider the following as a baseline:
a. SSB beams, in general, are considered to have wider beam-width; and
b. CSI-RS beams are narrower compare to SSB beams.

In an embodiment, the UE (100) performs measurements on the SSB, if the network apparatus (200) does not receive reporting quantity (for example, RSRP, SINR, etc.) on a (non-empty) set of SSB beams, then if there is no report received by one or more SSB beams, then the associated CSI beams of those SSB beams will become candidate for muting, and if no measurements has been received on a (non-empty) set of CSI-RS beams for a pre-configured period, then CSI-RS beams will become candidate for muting.

An indication can be provided to Ues (100) about muted CSI-RS ports to minimize UE measurements. This will have the additional benefit of reducing UE power consumption.

In an embodiment, before muting certain CSI-RS ports, in step 1, the network apparatus (200) can indicate a candidate list of CSI-RS ports for muting to all (or a group of) Ues (100). In step 2, the Ues (100) send measurements reports with an indication to restrict certain CSI-RS port(s) from become muting candidate(s) (if any). In step 3, the network apparatus (200) receives the measurement reports from the indicated Ues (100) and their preferences on muting of ports in the candidate list. It is up to the network apparatus's discretion to honour the UE's request. In step 4, the network apparatus (200) triggers new CSI-RS re-configuration with port-muting info for all (or a group of) Ues (100).

In an embodiment, before muting certain CSI-RS ports, the network apparatus (200) can perform CSI-RS re-configuration (with port-muting info) for all (or a group of) Ues (100) in the network (1000). After certain CSI-RS ports are muted, recovery is possible.

For recovery, in step 1, the UE (100) conducts measurements on SSB beams but does not find any CSI-RS beams associated with its preferred SSB beam(s). In a step 2, after the network apparatus (200) receives RSRP reports on a (non-empty) set of SSB beams, the network apparatus (200) can perform at least one of the following steps:
a) Step 2a: The network apparatus (200) can enable all CSI RS ports associated with the aforementioned SSB beams.
b) Step 2b: The network apparatus (200) can transmit CSI-RS beams or Discovery RS beams to identify which CSI-RS beams can be activated (per BWP/per CC basis).
c) Step 2c: The network apparatus (200) can send PDCCH to trigger the UE to send its positioning information using at least one of the following approaches:
i. A signal can be introduced in DCI info to trigger positioning info (for example, GPS-based or any other zone-/area-based positioning info). In an example, a triggering state corresponding to N sub-configurations is indicated via the existing CSI request field in the DCI. Different triggering states could represent different subsets of L subconfigurations. The DCI is UE specific (in this case, legacy DCI format applies), and
ii. Mapping of location with CSI-RS.

In step 3, the network apparatus (200) can choose to activate the set of CSI-RS beam(s) as per its discretion.

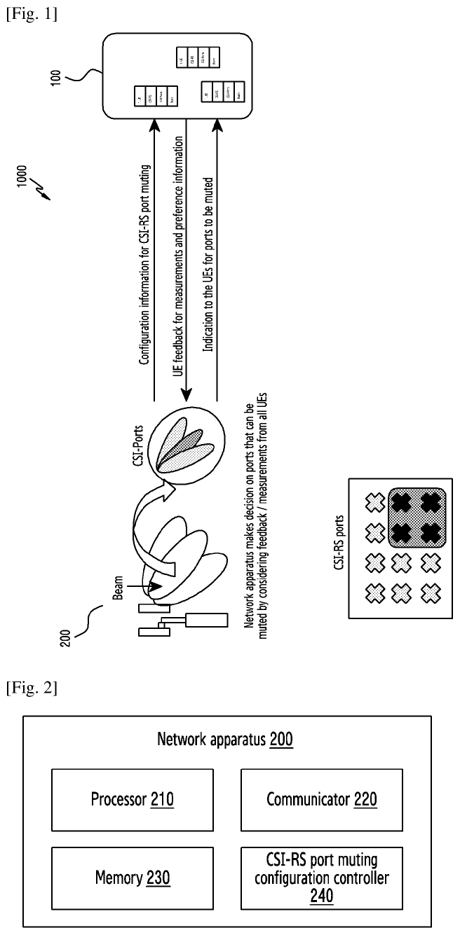

FIG. 2 shows various hardware components of the network apparatus (200), according to the embodiments as disclosed herein. In an embodiment, the network apparatus (200) includes a processor (210), a communicator (220), a memory (230) and a CSI-RS port muting configuration controller (240). The processor (210) is coupled with the communicator (220), the memory (230) and the CSI-RS port muting configuration controller (240).

The CSI-RS port muting configuration controller (240) sends a configuration message including the CSI-RS port muting information to the UE (100) for indicating to the UE (100) about the muted CSI-RS port to control the UE measurement of CSI using a CSI-RS signal. In an embodiment, the CSI-RS port muting information enables an antenna element and an antenna sub-array associated to a logical antenna port. In another embodiment, the CSI-RS port muting information disables the antenna element and the antenna sub-array associated to the logical antenna port. In an embodiment, the at least one CSI-RS port muting information is associated with at least one of: the at least one CSI-RS port, the at least one single group of CSI-RS ports, and the at least one multiple groups of CSI-RS ports.

In an embodiment, the CSI-RS port muting configuration controller (240) indicates one of: the CSI-RS port, the single group of CSI-RS ports, and the multiple groups of CSI-RS ports for port muting to the UE (100). Based on the indication, the CSI-RS port muting configuration controller (240) receives the measurement report from the UE (100). The measurement report can be, for example, but not limited to a RSRP measurement report, a SINR measurement report, a RSRQ measurement report, a CRI, a RI, a LI, a PMI, and a CQI. The measurement report includes the preference and measurement information about the port muting for one of: the CSI-RS port, the single group of CSI-RS ports, and the multiple groups of CSI-RS ports. Further, the CSI-RS port muting configuration controller (240) sends the configuration message including the port muting information to the UE (100) based on the measurement report received by the network apparatus (200).

Based on the configuration message including the CSI-RS port muting information and the subsequent UE measurement report, the CSI-RS port muting configuration controller (240) controls the energy usage in the wireless network (1000)

Further, the CSI-RS port muting configuration controller (240) receives the measurement report for the set of SSB beams by the UE (100) conducting the measurement on the set of SSB beams, where the UE (100) does not find the CSI-RS beam associated with the optimal SSB beam from the set of SSB beams. In an embodiment, the CSI-RS port muting configuration controller (240) enables all CSI-RS ports and beams associated with the set of SSB beams. In another embodiment, the CSI-RS port muting configuration controller (240) transmits the CSI-RS beams or a discovery RS beams to identify which CSI-RS beams to be activated per BWP and per CC basis. In an embodiment, the CSI-RS port muting configuration controller (240) sends a PDCCH to trigger the UE (100) to send a positioning information. The positioning information is determined using at least one of: a signal that is introduced in a DCI to trigger positioning information feedback from the UE (100) and mapping of location with the CSI-RS measurements. Based on the measurement report, the CSI-RS port muting configuration controller (240) selects and activates the set of CSI-RS beam from the set of SSB beams.

The CSI-RS port muting configuration controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (210) may include multiple cores and is configured to execute the instructions stored in the memory (230).

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 2 shows various hardware components of the network apparatus (200) but it is to be understood that other embodiments are not limited thereon. In other embodiments, the network apparatus (200) may include less or more number of components. Further, the labels or names of the components are used only for illustrative purpose and does not limit the scope of the invention. One or more components can be combined together to perform same or substantially similar function in the network apparatus (200).

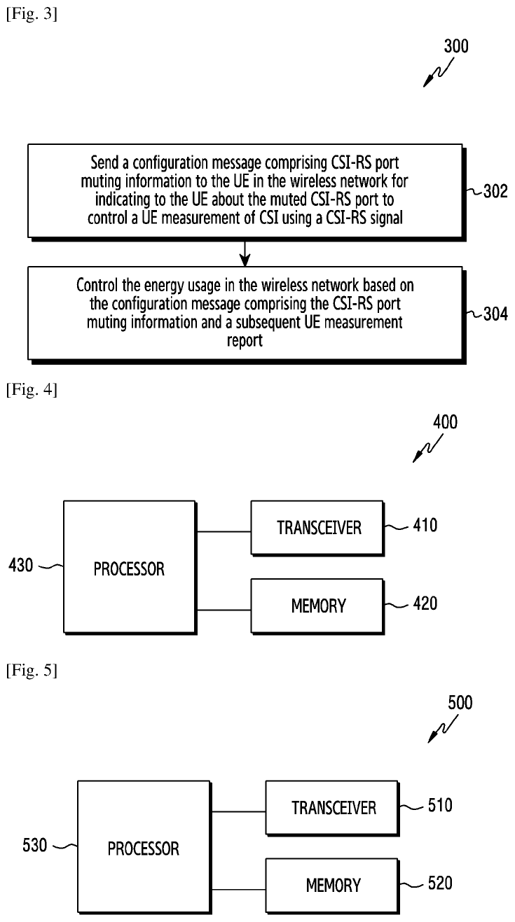

FIG. 3 is a flow chart (300) illustrating a method for managing energy usage in the wireless network (1000), according to embodiments as disclosed herein. The operations (302-304) are handled by the CSI-RS port muting configuration controller (240).

At step 302, the method includes sending the configuration message including the CSI-RS port muting information to the UE (100) in the wireless network (1000) for indicating to the UE (100) about the muted CSI-RS port to control the UE measurement of CSI using the CSI-RS signal. At step 304, the method includes controlling the energy usage in the wireless network (1000) based on the configuration message comprising the CSI-RS port muting information and the subsequent UE measurement report.

FIG. 4 illustrates a structure of a base station according to an embodiment of the disclosure.

As shown in FIG. 4, the base station according to an embodiment may include a transceiver 410, a memory 420, and a processor 430. The transceiver 410, the memory 420, and the processor 430 of the base station may operate according to a communication method of the base station described above. However, the components of the base station are not limited thereto. For example, the base station may include more or fewer components than those described above. In addition, the processor 430, the transceiver 410, and the memory 420 may be implemented as a single chip. Also, the processor 430 may include at least one processor. Furthermore, the base station of FIG. 4 corresponds to the base station in embodiments of other Figures described above. A base station may correspond to a network apparatus including a gNB, a eNB or like.

The transceiver 410 collectively refers to a base station receiver and a base station transmitter, and may transmit/receive a signal to/from a terminal (UE) or a network entity. The signal transmitted or received to or from the terminal or a network entity may include control information and data. The transceiver 410 may include a RF transmitter for up-converting and amplifying a frequency of a transmitted signal, and a RF receiver for amplifying low-noise and down-converting a frequency of a received signal. However, this is only an example of the transceiver 410 and components of the transceiver 410 are not limited to the RF transmitter and the RF receiver.

Also, the transceiver 410 may receive and output, to the processor 430, a signal through a wireless channel, and transmit a signal output from the processor 430 through the wireless channel.

The memory 420 may store a program and data required for operations of the base station. Also, the memory 420 may store control information or data included in a signal obtained by the base station. The memory 420 may be a storage medium, such as read-only memory (ROM), random access memory (RAM), a hard disk, a CDROM, and a DVD, or a combination of storage media.

The processor 430 may control a series of processes such that the base station operates as described above. For example, the transceiver 410 may receive a data signal including a control signal transmitted by the terminal, and the processor 430 may determine a result of receiving the control signal and the data signal transmitted by the terminal.

FIG. 5 illustrates a structure of a UE according to an embodiment of the disclosure.

As shown in FIG. 5, the UE according to an embodiment may include a transceiver 510, a memory 520, and a processor 530. The transceiver 510, the memory 520, and the processor 530 of the UE may operate according to a communication method of the UE described above. However, the components of the UE are not limited thereto. For example, the UE may include more or fewer components than those described above. In addition, the processor 530, the transceiver 510, and the memory 520 may be implemented as a single chip. Also, the processor 530 may include at least one processor. The UE of FIG. 5 corresponds to the UE in embodiments of other Figures described above.

The transceiver 510 collectively refers to a UE receiver and a UE transmitter, and may transmit/receive a signal to/from a base station or a network entity. The signal transmitted or received to or from the base station or a network entity may include control information and data. The transceiver 510 may include a RF transmitter for upconverting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

Also, the transceiver 510 may receive and output, to the processor 530, a signal through a wireless channel, and transmit a signal output from the processor 530 through the wireless channel.

The memory 520 may store a program and data required for operations of the UE. Also, the memory 520 may store control information or data included in a signal obtained by the UE. The memory 520 may be a storage medium, such as read-only memory (ROM), random access memory (RAM), a hard disk, a CD-ROM, and a DVD, or a combination of storage media.

The processor 530 may control a series of processes such that the UE operates as described above. For example, the transceiver 510 may receive a data signal including a control signal transmitted by the base station or the network entity, and the processor 530 may determine a result of receiving the control signal and the data signal transmitted by the base station or the network entity.

The various actions, acts, blocks, steps, or the like in the flow chart (300) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

Those skilled in the art will understand that the various illustrative logical blocks, modules, circuits, and steps described in this disclosure may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this disclosure.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this disclosure may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method performed by a base station, BS, in a wireless communication system, the method comprising:
transmitting, to a user equipment, UE, a message for configuring a list of channel state information reference signal (CSI-RS) ports for muting for a network energy saving; and
receiving, from the UE, a channel state information (CSI) report based on the message, the CSI report including information on a CSI-RS port among the list of CSI-RS ports.

2. The method of claim 1, wherein all antenna elements associated with a CSI port are disabled for the network energy saving.

3. The method of claim 1,
wherein the message includes at least one sub-configuration for the CSI report, and
wherein each of the at least one sub-configuration includes same number of CSI-RS ports.

4. The method of claim 1, further comprising:
transmitting, to the UE, Downlink Control Information, DCI, for triggering of the CSI report.

5. A base station, BS, in a wireless communication system, the BS comprising:
a transceiver;
a processor coupled with the transceiver and configured to:
transmit, to a user equipment, UE, a message for configuring a list of channel state information reference signal (CSI-RS) ports for muting for a network energy saving; and
receive, from the UE, a channel state information (CSI) report based on the message, the CSI report including information on a CSI-RS port among the list of CSI-RS ports.

6. The BS of claim 5,
wherein all antenna elements associated with a CSI port are disabled for the network energy saving.

7. The BS of claim 5, wherein the message includes at least one sub-configuration for the CSI report, and
wherein each of the at least one sub-configuration includes same number of CSI-RS ports.

8. The BS of claim 5, the processor further configured to:
transmit, to the UE, Downlink Control Information, DCI, for triggering of the CSI report.

9. A method performed by a user equipment, UE, in a wireless communication system, the method comprising:
receiving, from a base station, BS, a message for configuring a list of channel state information reference signal (CSI-RS) ports for muting for a network energy saving; and
transmit, to the BS, a channel state information (CSI) report based on the message, the CSI report including information on a CSI-RS port among the list of CSI-RS ports.

10. The method of claim 9, wherein all antenna elements associated with a CSI port are disabled for the network energy saving.

11. The method of claim 9, wherein the message includes at least one sub-configuration for the CSI report, and
wherein each of the at least one sub-configuration includes same number of CSI-RS ports.

12. The method of claim 9, further comprising:
receiving, from the BS, Downlink Control Information, DCI, for triggering of the CSI report.

13. A user equipment, UE, in a wireless communication system, the UE comprising:
a transceiver;
a processor coupled with the transceiver and configured to:
receive, from a base station, BS, a message for configuring a list of channel state information reference signal (CSI-RS) ports for muting for a network energy saving; and
transmit, to the BS, a channel state information (CSI) report based on the message, the CSI report including information on a CSI-RS port among the list of CSI-RS ports.

14. The UE of claim 13, wherein all antenna elements associated with a CSI port are disabled for the network energy saving.

15. The UE of claim 13, the processor further configured to:
receive, from the BS, Downlink Control Information, DCI, for triggering of the CSI report; and
wherein the message includes at least one sub-configuration for the CSI report, and
wherein each of the at least one sub-configuration includes same number of CSI-RS ports.
